(19) United States
(12) Patent Application Publication
(10) Pub. No.: US 2014/0176717 A1
(43) Pub. Date: Jun. 26, 2014

(54) DEVICES TO EQUIP VEHICLES WITH CLOSED CIRCUIT TELEVISION BACKUP SYSTEM

(71) Applicant: Roberto De Paschoal, Vancouver (CA)

(72) Inventor: Roberto De Paschoal, Vancouver (CA)

(21) Appl. No.: 14/195,706

(22) Filed: Mar. 3, 2014

Related U.S. Application Data
(63) Continuation-in-part of application No. 13/351,973, filed on Jan. 17, 2012, now Pat. No. 8,665,332.

(51) Int. Cl. H04N 7/18

(52) U.S. Cl. CPC H04N 7/183
USPC 348/148

(57) ABSTRACT

A mechanism to secure a closed circuit camera to a vehicle includes a securing mechanism and a locking system, wherein locking the locking system provides power to the camera, allowing it to communicate with a monitor within the vehicle to allow a driver to see the camera's transmissions. The communication includes a synchronization protocol, such as Bluetooth® SSP, that ensures the camera and monitor are communicating exclusively with one another, avoiding cross-talk or other interference from nearby systems. The securing mechanism can take the form of various clamping devices, magnets, suction devices or other appropriate means to secure the assembly to the vehicle.

### CROSS REFERENCE TO RELATED APPLICATIONS

This application is a continuation in part of U.S. application Ser. No. 13/351,973, filed Jan. 17, 2012, and claims the benefit of the following, the disclosures of which are expressly incorporated by reference herein: U.S. Provisional Patent Application No. 61/461,352, filed Jan. 18, 2011; U.S. Provisional Patent Application No. 61/518,308, filed May 4, 2011; and U.S. Provisional Patent Application No. 61/574,434, filed Aug. 3, 2011.

### FIELD OF THE INVENTION

This invention is related to a system comprising a camera removably secured to the rear of a vehicle, a monitor in communication with the camera and a locking mechanism which both secures the camera and controls the communication between the camera and the monitor.

### BACKGROUND AND SUMMARY OF THE INVENTION

Currently, rearview cameras are readily available to passenger vehicles and to some fleet-based tractor trailers to greatly improve the driver's view behind the vehicle. Many tractor trailer drivers cannot employ these cameras, however, because these drivers frequently haul different trailers. There is therefore a need for a stable, yet removable, fixture to mount a closed caption television camera (CCTV) upon substantially any type of large truck trailer. Because of this camera mobility, there is also the need to ensure that images captured by the camera are correctly provided to the driver of whichever vehicle the camera is mounted on, by providing adaptable communications between the CCTV and the specific display system provided in the vehicle.

The invention comprises a CCTV removable system enabled by a mounting device for releasably securing a camera on the rear of the vehicle, and a locking mechanism which controls the secure attachment of the mounting device as well as the communications between the camera and a monitor mounted inside the vehicle.

The camera, placed at the rear of the vehicle(s) may be conventionally wired to the TV monitor placed inside the cab of the truck through a long cable connecting each other. The system may, however, alternatively be done in a wireless manner with one or more transmitting antenna(s) connected to the camera(s) and one or more receiving antennas attached to the very back of the tractor chassis and wired to the viewing monitor. For a straight truck version, the receiving antenna(s) may be alternatively installed somewhere else upon the vehicle. One major benefit of a wireless system is the opportunity to move the camera between vehicles, and to be able to recalibrate or re-synchronize it each time, to communicate properly only with the monitor associated the particular vehicle on which the camera is mounted. An example of a suitable protocol under which the camera may be moved and re-synchronized to different display monitors is a Bluetooth® Secure Simple Pairing (SSP) protocol. However, it is also preferable to ensure that such communications take place only once the system is properly secured to the vehicle. This acts as an anti-theft deterrent, as the system will not work if the locking mechanism is not properly secured. In addition, it provides peace of mind to the vehicle operator, as it will reassure the operator that the camera is securely mounted on the vehicle and communicating only with the in-cab monitor, and that the monitor is not receiving images from another camera.

The transmitting antenna(s) may be placed close to the ground sending signals to the receiving one(s), installed also near the pavement for unobstructed wireless transmission within the ground clearance of the vehicle(s).

It will be understood that mentioned transmission could alternatively be done overhead, on the sides of the vehicles, etc., by providing appropriate hardware to hold the antennas in pertinent configurations.

In order to activate the system also when the tractor is not coupled to any trailer, there may be another hardware device to be permanently installed on the back of the tractor, which may feature replicas of segments of the fixtures or mechanisms where the camera(s) and accessory devices would be alternatively clamped onto when at the back of the trailer or maritime container.

Still further objects and advantages of the invention will become readily apparent to those skilled in the art to which the invention pertains upon reference to the following detailed description.

### BRIEF DESCRIPTION OF THE DRAWINGS

The description refers to the accompanying drawings in which like reference characters refer to like parts throughout the several views, and in which:

FIG. 1 is a side view of a first embodiment of the clamp;

FIG. 2 is a detail view of the locking swing handle of the clamp of FIG. 1;

FIG. 3 is a side view of the upper plate of the clamp of FIG. 1;

FIG. 4 is a side view of the lower plate of the clamp of FIG. 1;

FIG. 5 is a side view of a second embodiment of the clamp;

FIG. 6 is a front view of the clamp of FIG. 1, mounted to a trailer's locking rod;

FIG. 7 is a front view of the clamp of FIG. 5;

FIG. 8 is an exemplary view of a wireless camera antenna;

FIG. 9 is a plan view of a retention clip for retaining a camera wire along the length of a trailer;

FIG. 10 is a side view of an alternate embodiment of the clamp of the invention, having adjustable clamps;

FIG. 11 is a front view of the alternate embodiment of FIG. 10;

FIG. 12 is side view of a magnet secured embodiment of the clamp;

FIG. 12A is an enlarged view of the angle adjustment feature of the embodiment of FIG. 12;

FIG. 13 is a front view of the embodiments of FIGS. 12 and 12A;

FIG. 14 is a side view of the bobtail-only mounting bracket;

FIG. 14A is a top view of the camera plate mounted to a vertical standard;

FIG. 15 is a front view of the embodiment of FIGS. 14 and 14A;

FIG. 16 is a side view of another embodiment of the invention;

FIG. 17 is a front view of the embodiment of FIG. 16;

FIG. 18 is a side view of another embodiment of the invention;

FIG. 19 is an enlarged view of the locking mechanism in FIG. 18;

FIG. 20 is a plan view of the locking mechanism of FIG. 18; and

FIG. 21 is a front view of the embodiment of FIG. 18.

FIG. 22 is a side view of another embodiment of the invention;

FIG. 23 is an enlarged view of the locking mechanism in FIG. 22 in a first position;

FIG. 24 is an enlarged view of the locking mechanism of FIG. 22 in a second position;

FIG. 25 is an enlarged top view of the locking mechanism of FIG. 22;

FIG. 26 is a side view of another embodiment of the securing mechanism of the invention;

FIG. 27 is a top view of the embodiment of the mechanism of FIG. 26;

FIG. 28 is a side view of another embodiment of the securing mechanism of the invention;

FIG. 29 is a top view of the embodiment of the mechanism of FIG. 28;

FIG. 30 is a side view of another embodiment of the securing mechanism of the invention;

FIG. 31 is a top view of the embodiment of the mechanism of FIG. 30;

FIG. 32 is a top view of another embodiment of the securing mechanism of the invention; and

FIG. 33 is a top view of a securing mechanism similar to that of in FIG. 32, with a different configuration.

### DETAILED DESCRIPTION OF THE INVENTION

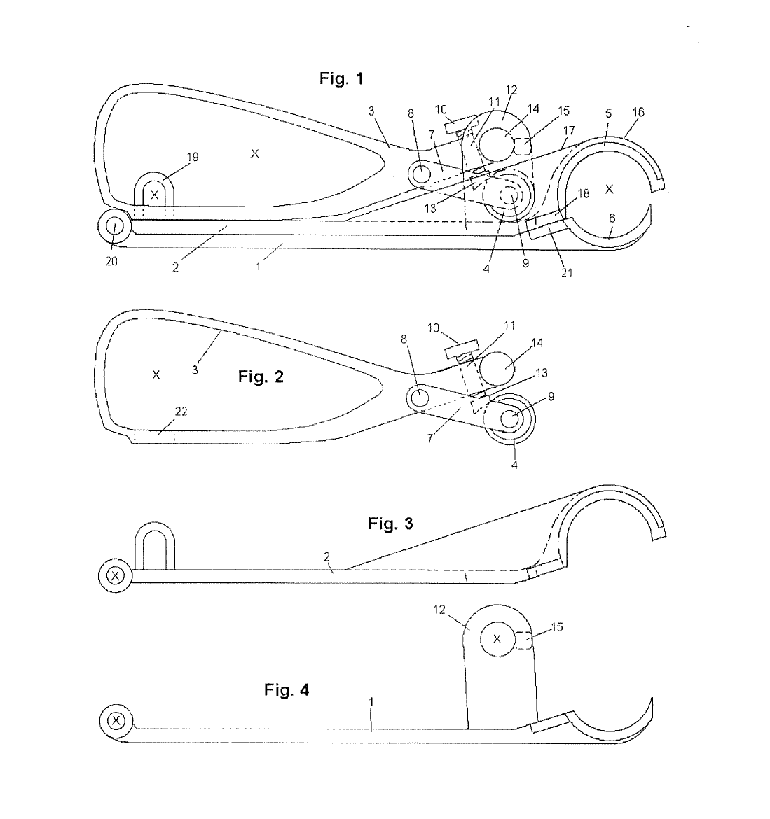

Referring now to FIGS. 1-15, a first embodiment of a CCTV mounting system is illustrated and is divided in three components:

The clamping mechanism with a plate holding the camera(s) optional battery box and wiring for AND the transmitting antenna(s) to be installed at the very end of the vehicle(s).

The optional apparatus to be permanently attached to the back of the tractor's cab to be used whenever vehicle is not attached to any trailer (bobtailing). This item is obviously not applicable to straight trucks.

The receiver/monitor TV screen wired straight to the camera or alternatively to the receiving antenna(s) for wireless transmission.

There are four basic versions of systems for installing CCTV systems on commercial vehicles:

For trucks, trailers, maritime containers, intermodals, etc. with revolving vertical locking rods installed on hinged, swing type cargo doors, the snap-on/off securing mechanism may clamp horizontally onto the mentioned rods.

For trucks, trailers, cargo containers, etc., with rollup type cargo doors, which snap-on/off securing mechanism may clamp vertically onto the horizontal handle bar of those doors.

For trucks and trailers without any cargo door mechanisms to host the devices above mentioned, when the securing mechanism may be clamped onto the back of the D.O.T. rear bumper or any other rearmost area of the vehicle(s).

For vehicle carriers without any surface to which a camera system may be clamped, the securing mechanism may include a suitable attachment device, such as magnets, suction cups, other suitable devices, or combinations of these, to be attached to an exposed face of the rearmost automobile or alternatively to the surrounding hardware whenever the trailer is unloaded.

Referring now to FIGS. 1-4 and 6, a preferred embodiment of the clamping device of the invention, is shown. The assembled device having two flat plates 1 and 2 hinged together at pivot pin 20 with jaws 5 and 6 that are configured to receive and grip the vertical locking rods of the above mentioned typical cargo doors. Plate 1 has two identical flat guide plates 12 protruding upwards and traveling through plate 2 which cooperatively define a yoke have round orifices for hosting the axles 14 which permit handle bar 3 to be rotatably coupled to the lower plate 1. The handle bar 3 protrudes outwardly and rotating on both sides in order to allow vertical swing motion of said bar. In one preferred embodiment, bar 3 also has a roller 4 for securing purposes, attached to a control arm 7 and secured by axles 8 and 9. Bolt 10 may penetrate a threaded hole 11 formed in handle bar 3, and may rotate to adjust the tension of the system by extending or retracting the central beam of “H” bar 13. In one non-limiting embodiment a transversal bar 15 may span the yoke formed by both plates 12 to hold these plates 12 in parallel alignment. A horseshoe-shaped loop 19 is installed onto plate 2 that may penetrate the slot of handle 3 shown on 22 of FIG. 2, where a padlock may be inserted through in order to prevent disengagement and theft of the equipment.

The upper jaw 16 on plate 2 may have a pair of reinforcing central surfaces or webs 17 which extends at an angle interconnecting the upper portion of jaw 16 to the plate 2. These support webs 17 run adjacent to the yoke plates 12. Similarly, reinforcing corner wedges 18 and 21 extend outwardly to support the elongated clamp jaws. In this manner, both plates 1 and 2 may have reinforcing material at the high stress area on and near the jaws.

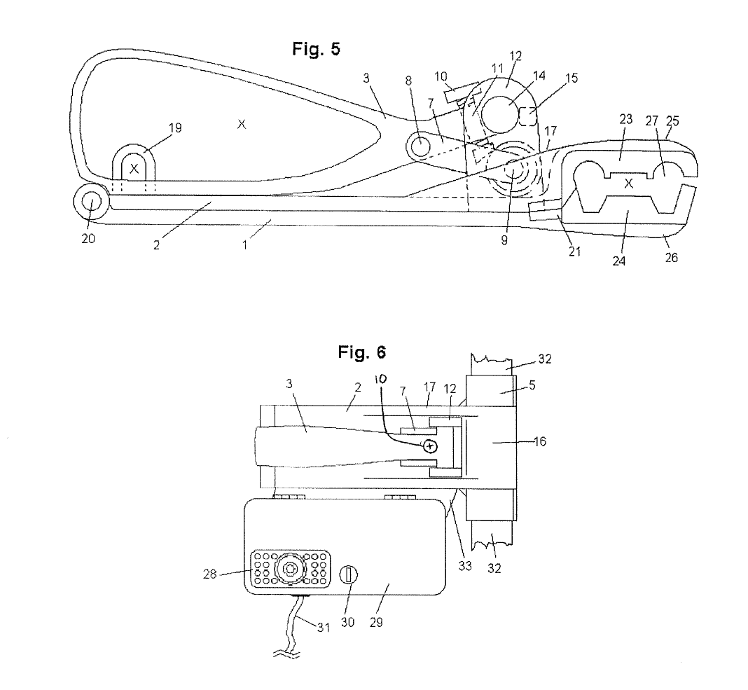

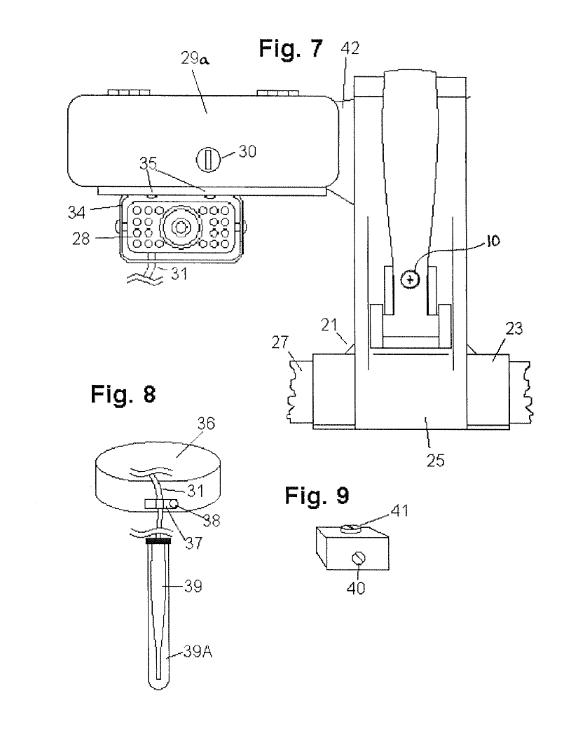

Referring now to FIG. 5 a profile view of an alternate embodiment of the securing mechanism is shown. This embodiment is very similar to the one described above except for its different locking jaws, in this case is especially designed to be used on Whiting® models of door handles 27. Obviously other designs may be carried out for different configuration of handles. In this embodiment upper jaw 23 and lower jaw 24 both extend beyond the edges of the devices are the reinforcing surfaces 25 and 26, which are limited to the center area of the apparatus, as shown in FIG. 7. Like the first embodiment, the jaws are supported by reinforcing bracing such as corner reinforcing wedge 21. All other numbers may be similar to the ones of FIG. 1.

Referring back to FIG. 6 an upper view of the securing mechanism is illustrated installed on the vertical rod 32 of a cargo vehicle/trailer, showing the parts mentioned on FIG. 1, plus a mounting plate 33 which is coupled to the lower surface of plate 1 by conventional means, such as threaded fasteners. Mounted to the plate 33 is a secure storage box 29 enclosing a conventional rearview CCTV camera 28, an optional battery, and the wiring connecting to the camera 28. The camera is contained within box 29 behind a transparent window located in the front wall of the box's casing and secured by a lock mechanism 30. The video camera may be connected to the monitor in the tractor's cabin in a wired version using cable 31, or alternatively using the same cable to a transmitting antenna placed nearby for wireless transmission.

Similarly, FIG. 7 illustrates is an upper view of the alternate embodiment of the securing mechanism installed on a Whiting® brand door handle 27, attached to the camera system by a plate 42, which holds a separate optional battery box 29a and a weather resistant CCTV camera 28 mounted on a frame 34 and secured via fasteners 35 to the support plate 42.

Referring now to FIG. 8, an optional magnet 36, which may be installed on rear bumpers of adjacent area, for wireless systems, which hold wire 31 stopped at tie 37, snapped in at 38, may connect camera 28 to a transmitting antenna 39. Antenna 39 may be protected from flying debris by a resilient removable enclosure 39A.

FIG. 9 shows one of the small blocks of magnet or any other material that may be used to secure the cable 31 (going through orifice 40 and tightened by tablet bolt 41) connecting a TV monitor in the vehicle's cabin for the driver's view, through the chassis to the receiving antenna installed at the rear end of the tractor, probably using also the device of FIG. 8 for hanging the antenna.

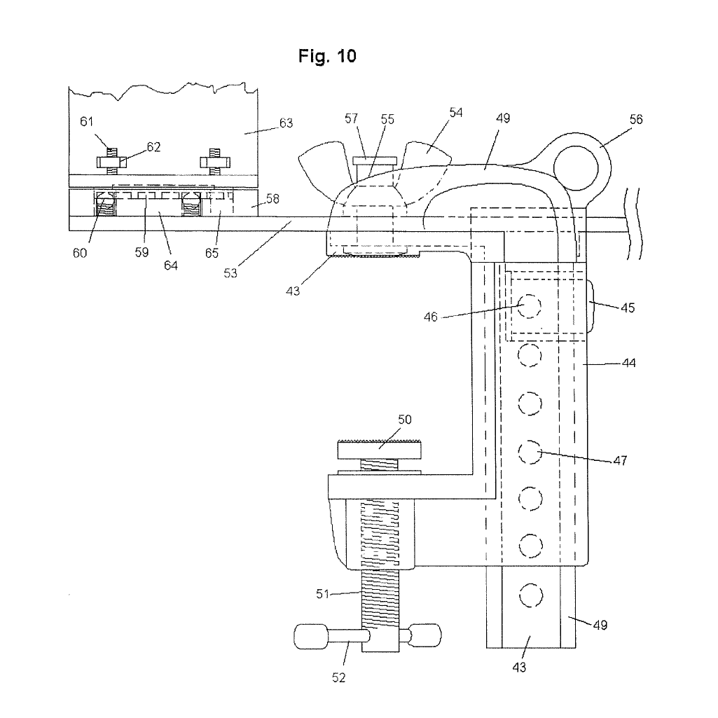

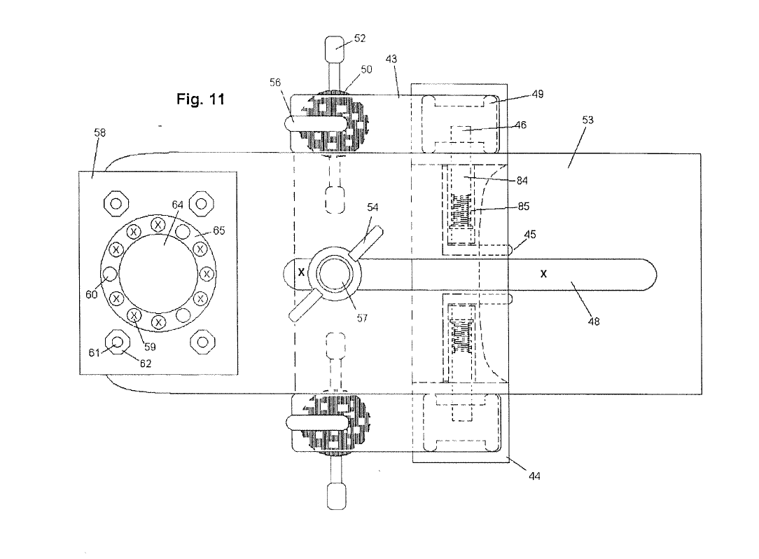

FIGS. 10 and 11 show another alternate embodiment of the clamp portion of the invention, with the securing mechanism to be clamped onto the back of the rear bumper of trucks and trailers, which may be secured in between by a pair of “C-clamp” configured grippers having opposing upper jaws 43 and a rotary platform 50 which are rotated/tightened by bars 52 rotating around the thread 51. The clamp jaws are secured at body or frame 44, which may slide up and down elongated railings 43 whenever the securing mechanism is to be adjusted. For that purpose, levers 45 may be squeezed in releasing pins 46, which may stop, entering one of the slots 47 at the desired height. Protruding edges 49 may guide and reinforce the whole system between the sliding engagement of rails 43 and frame 44. There is also a flat plate 53 sliding in between the two jaws 43, which may adjust the lengthwise positioning of the camera system (retained by bracket 63) by the release of the wing-nut 54 rotating around the threaded shaft 55 and with a stopping crown 57. At least one loop 56 located on top of the edge 49 may be run through with a wire rope or similar security equipment attached to a padlock to prevent theft. At the other end, on top of plate 53 we may see the foundation for the camera/battery attachment, where base 58 may hold a carousel system that allows the camera, whose frame 63 may be secured by the bolts 61 and nuts 62, to turn sideways whenever desired. The system may rotate around round plate 64, where carousel 65 may have empty cups 59 which may be filled with spheres 60 with a spring expanding it to the top, thus, providing a natural click stop whenever desired level is reached. Additional aerodynamic equipment (cones, flaps, fairings, etc. not showing) may be installed on the apparatus in order to avoid droplets of water, snow or ice to interfere with quality of image provided by the camera(s).

As shown in FIG. 11, the twin adjustable clamps 43 with frame 44 moving up and down when tabs 45 are squeezed together and retracting the locking pins 84 out of the cavities 46. It may automatically click to the next stop by the force of the expanding spring 85. Plate 53 may be adjustable sideways by the release of the wing nut 54 traveling around 57, and sliding through the slot 48 and guided by the inner walls of 43. 58 is the pad where the camera/battery box may be installed upon, mounted through the bolts 61 and locked by the nuts 62. The side angle camera adjustment could be done by rotating the whole unit, around center core 64, making the balls 60 to skip cups 59 of carousel 65 until desired position is achieved.

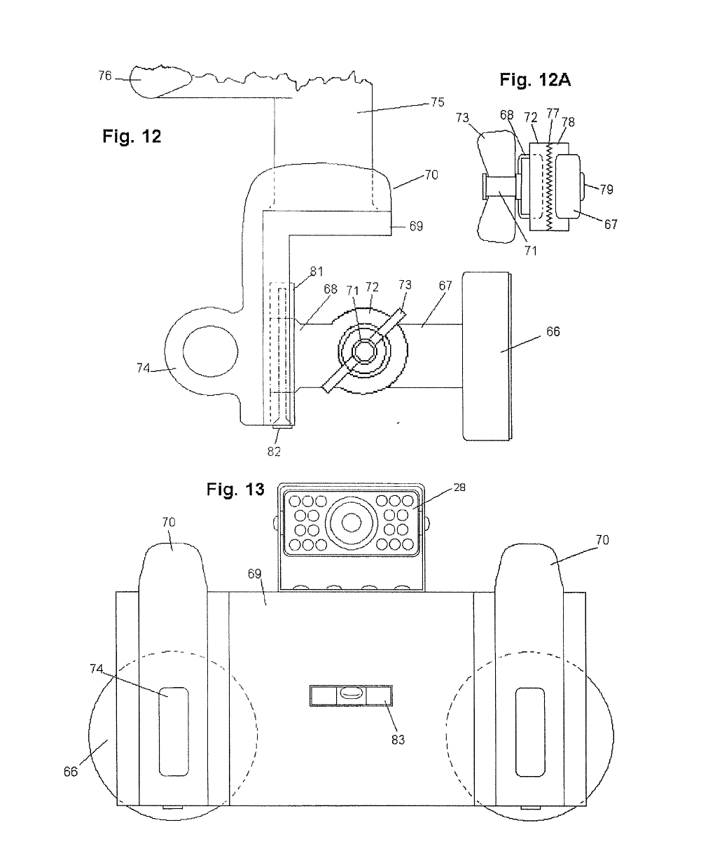

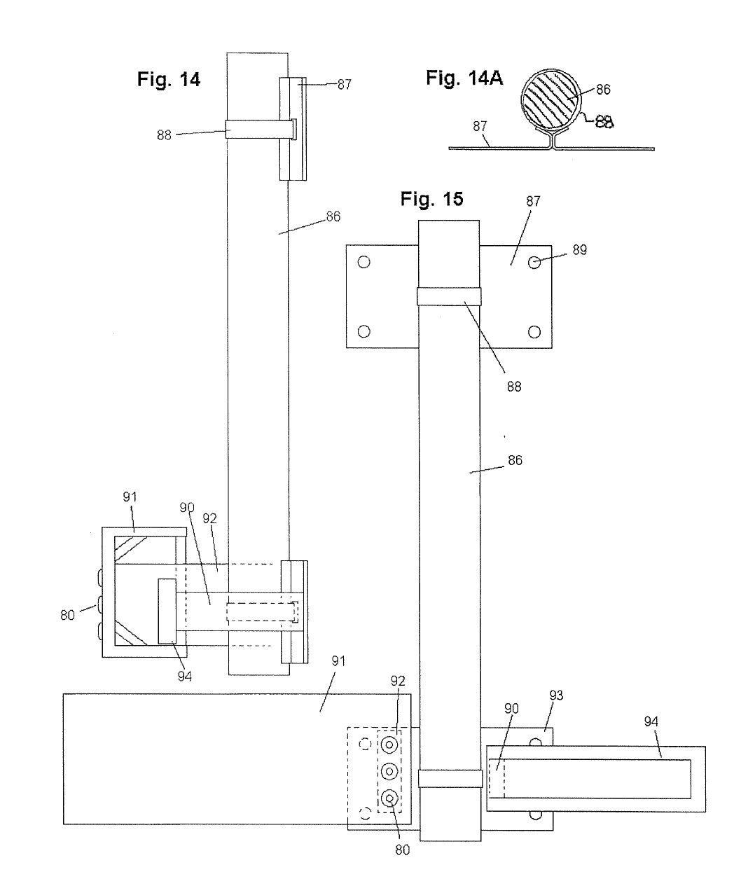

Referring now to FIGS. 12, 12A and 13, another alternate embodiment is of the securing mechanism is illustrated, in this embodiment, the securing mechanism is especially configured for vehicle carriers with no surfaces to be clamped onto. In this case the system is attached magnetically to the very rearmost vehicle's body surface by magnet 66 which may be held by shaft 67 and 68 to the angle bar 69 of structure 70. In the embodiment illustrated in FIG. 12 an elongated pole 75 extends from the magnet-held angle plate 69 which is similar to the pole 86 of FIGS. 14 and 15 described below. In the embodiment illustrated in FIG. 13, the camera 28 and optional battery box (not shown) is mounted directly to the magnet-supported plate 69. Loops 74 provide for a wire rope to be inserted to prevent theft. Bubble 83 may help drivers to install the equipment in the right level.

FIG. 12A is a mechanism to give up-and-down adjustment and independent flexibility to legs 67, by releasing the wing-nut 73 which may turn around axle 71, secured at hub 79 and by the force of the inner expanding spring (not showing), the intermeshing teeth 77 may open and separate segments 72 and 78 allowing rotary movements to whatever desired notch, and then tightened nut 73 to secure that side of the unit. Legs 68/67 may also have sideways independent flexibility in between the hinges 81 and adjusted in tension by pin 82. All this flexibility is to adjust to the contour of various vehicles to be transported.

FIGS. 14-15 illustrate the “bobtail” mount portion of the system, which may be attached permanently to the back of the tractors for alternatively hosting the camera system whenever there are no trailers attached thereto. Vertical standard or pipe 86 is configured to replicate the revolving locking rods of trailers and maritime containers to be clamped by the embodiment shown in FIGS. 1-4, and may be secured to plate 87 by clamp 88, and then bolted to the cabs through the holes 89. Bar 94 is a replica of the horizontal handle bar to be clamped onto by the mechanism of FIGS. 5 and 7, and it is attached to the component 2 by the solid bar 90. Bar 92 may hold the replica of a rear bumper 91, to be used by the version illustrated in FIGS. 10 and 11, which may be detached by the release of optional bolts 80.

FIG. 14A is an upper view of plate 87 holding pipe 86.

FIG. 15 is a front view of the system showing the pipe 86, handle 94, supported by bar 90, and bar 91 secured by block 92 and bolted by optional bolts 80. Plates 87 and 93 may be placed to the back surface of the tractor and bolted onto through the holes 89.

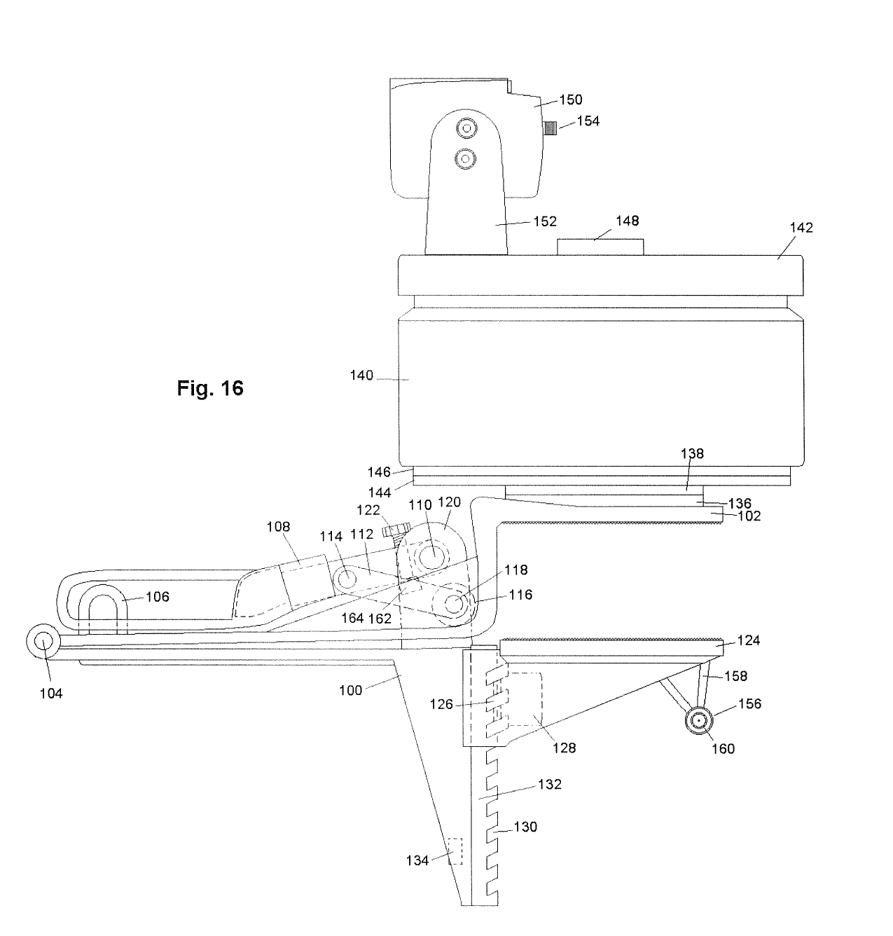

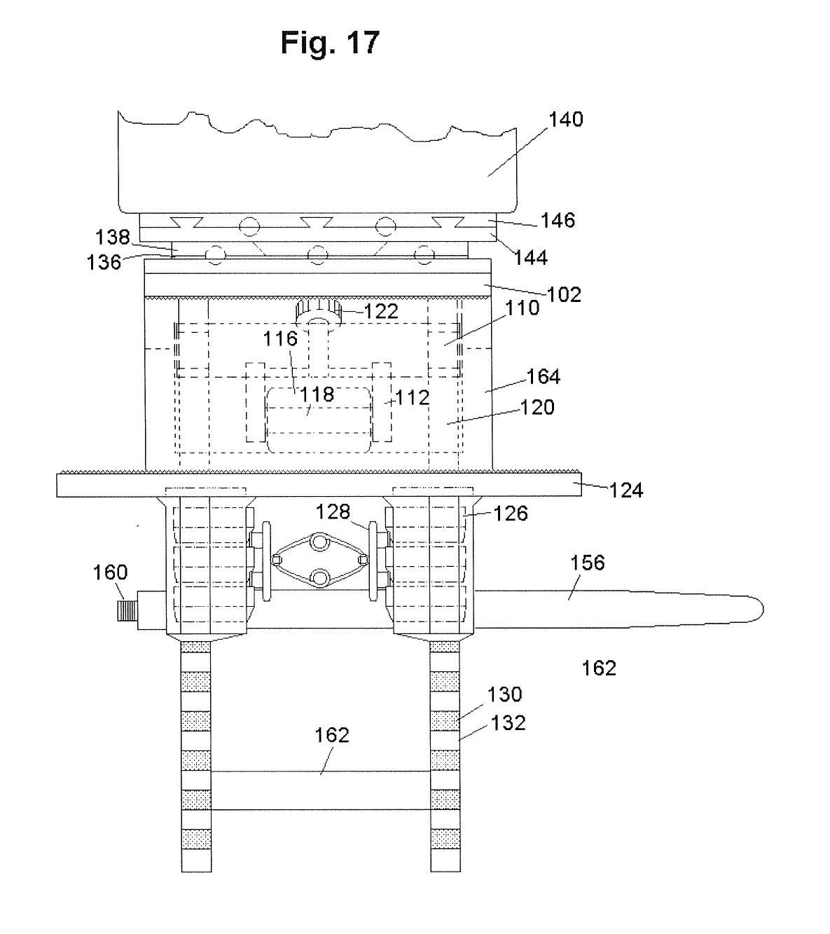

A further embodiment of the invention is shown in FIGS. 16 and 17. This embodiment provides a unit with a camera, an optional battery compartment and a transmitting antenna, all attached to a securing mechanism, such as clamping device 98 with adjustable jaws for attachment to any preferred bumper surface. A lower base plate 100 supports upper plate 102, with the two plates being joined through a pivoting joint 104. In some embodiments, a loop 106 or other suitable mechanism may be provided for a padlock to secure the clamping device 98. Handle 108 is provided to control the opening and closing of the clamping device 98, and is preferably pivoted 110 to a guide assembly 120 extending from base plate 100 through part of upper plate 102. Control arm 112 is preferably pivotably attached 114 along handle 108 at one end and to a tightener, such as tightening roller 116, at the other end. As best seen in FIG. 17, control arm 112 is preferably a pair of control arms separated by a cross-member 162 passing through axis 118 of tightening roller 116. One or more reinforcing members 164 may be provided outside of the control arm to protect and strengthen that area of the clamping device 98.

The position of tightening roller 116 is preferably adjustable, such as by knob 122, to adjust the clamping tension between upper plate 102 and a lower jaw plate 124. Protective means, such as tabs or other suitable means may be provided to protect knob 122 from being tampered with.

A locking mechanism is preferably provided to adjustably connect lower plate 124 to base plate 100. In the embodiment shown, the locking mechanism, which may be teeth 126, engages with notches 130 on one or more railings 132 extending from base plate 100. Tabs 128, biased apart by a mechanism such as spring assembly 172, may be provided as a means to engage and disengage teeth 126 from notches 130 to adjust the lower jaw plate 124 vertically on railings 132. One or more cross members 134 may be provided to strengthen the lower portion of railings 132.

An upper face 136 of upper plate 102 preferably contains a connector 138 to attach a compartment 140, capable of accommodating a battery and/or other components; lid 142 is preferably provided on compartment 140 to protect the components within compartment 140 from weather, theft or other external forces. Connector 138 is preferably rotatable with up to 360° mobility, to provide versatility in the placement and orientation of the battery compartment 140. Connector 138 may also be provided with a fixed plate 144, which engages with a sliding plate 146 on the bottom of battery compartment 140, to provide further flexibility in the placement of battery compartment 140. Lid 142 may be secured with a suitable means, such as knob 148.

In this embodiment, camera 150 is supported on top of lid 142 by brackets 152. However, it will be understood that the camera 150 may be secured with any suitable means or in any suitable location relative to the clamping device 98. Appropriate wired or wireless connections will be provided between the transmitting antenna 156 and the camera 150 but are omitted for clarity. A connector 154 may be provided to connect transmitting antenna 156 to camera 150. Antenna 156 is supported in any suitable way, but is preferably supported and secured out of the way. In the embodiment shown, the transmitting antenna 156 is secured behind the vehicle bumper (not shown) on which the clamping device 98 is mounted, by bracket 158, and is provided with connector 160 to connect the antenna 156 to the camera 150.

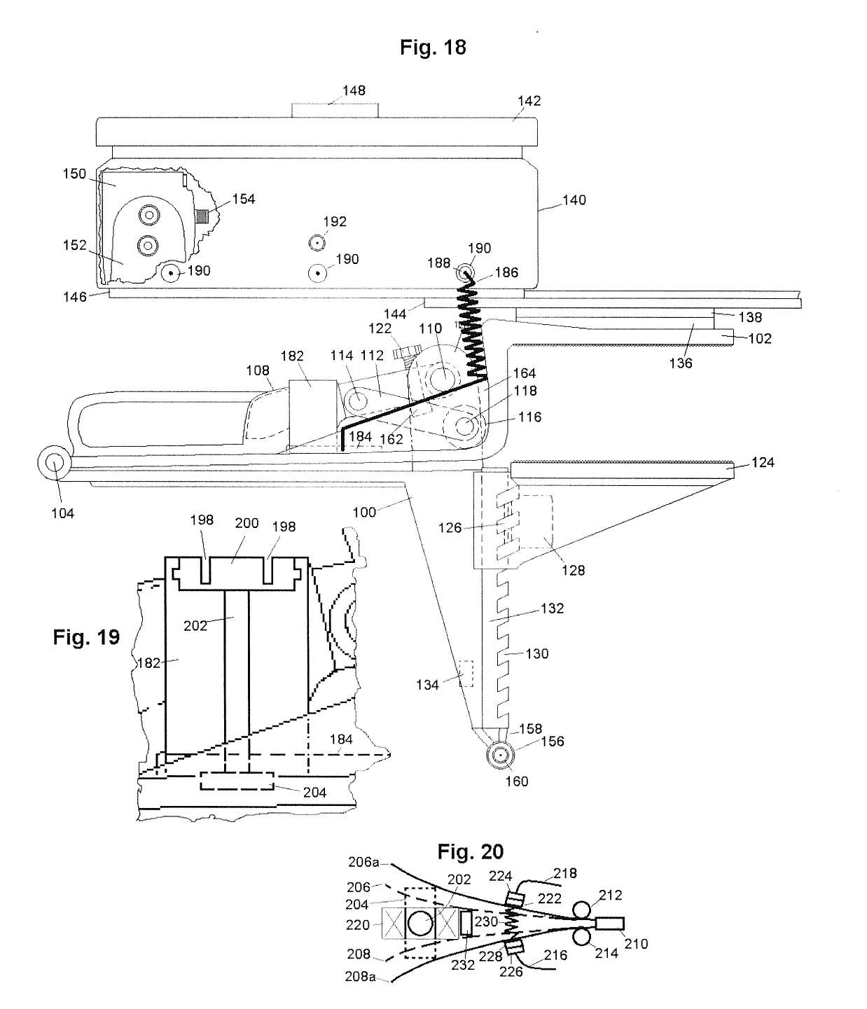

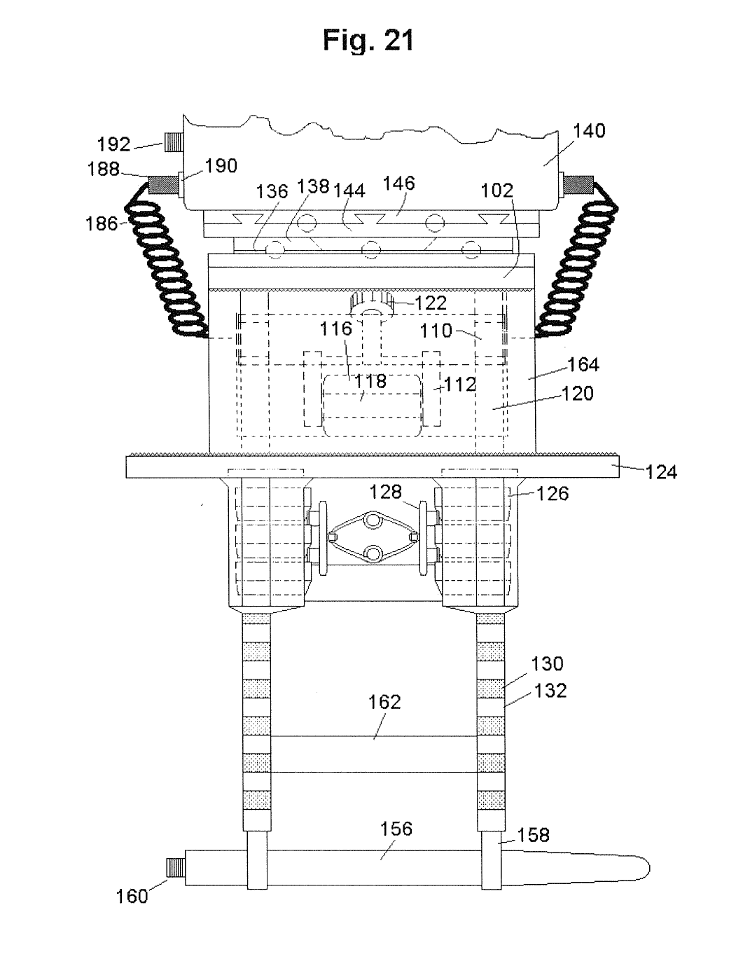

In the embodiment shown in FIGS. 18-21, camera 150 is accommodated within battery compartment 140. The assembly has a locking mechanism 182, which will securely lock handle 105 into fixed plate 184, by the turn of a cylinder key (not shown), which could also lock battery compartment 140 by a disk arrangement similar to the one portrayed on FIG. 19, installed on the façade of knob 148. In this embodiment, no padlock is strictly required, and any clamping device used therefore need not include a means to accommodate a padlock, such as loop 106. A single key may be used to lock the whole system. In addition, this embodiment preferably contains connections through which the actuation of the locking mechanism 182 allows the camera 150 to activate only once the system is properly locked in place on a vehicle bumper, which helps to prevent loss and theft. Further, the activation of the camera system preferably also activates a wired or wireless communication through antenna 156 between the camera 150 and the monitor (not shown) within the vehicle cab. The communication preferably includes initialization of a synchronization protocol, under which the camera 150 and monitor synchronize and pair with each other, to ensure that they are properly communicating only with one another, excluding other devices and avoiding any possibility for cross-talk or interference from other nearby systems. One example of such a synchronization protocol is Bluetooth® SSP, but any similar protocol which accomplishes the same synchronization and can therefore provide the same security that the image being transmitted to the monitor is from the camera mounted on the correct vehicle, may be used.

In an exemplary embodiment including the locking mechanism, opposed wires 186 connect the circuitry from the electrical source to the camera 150 through connector 188 and sockets 190. It will be understood that the number and placement of sockets 190 can be varied depending the length and flexibility of wiring 186. Antenna connector 192, similar to connector 154 shown in FIG. 16, may be provided on the battery compartment 140 to connect the camera to the transmitting antenna 156 for wireless functions. Alternatively, antenna connector 192 could be replaced by an orifice drilled through a sidewall of compartment 140, to accommodate a cable travelling from connector 154 at back of the camera 150 straight to connector 160 of the transmitting antenna 156.

FIG. 19 is a detailed view of the locking mechanism in this embodiment of the invention, where locking mechanism 142 includes cylinder 194 which houses revolving disk plate 200. Disk plate 200 turns only when an appropriate cylindrical key is inserted into the circular groove 198, driving the shaft 202 and rotating block 204, thereby locking or opening the handle 108 of clamping device 98.

FIG. 20 is a schematic top view of the locking hardware and circuitry that will associate the activation of the camera 150 with the locked or unlocked status of the system. The block 204 rests on a top surface of the plate 196 when the key is turned all the way to the “open” position, and will engage with an orifice 220 in the plate 196 whenever the key is positioned in the “locked” position. Flexible rods 206 and 208 extend from block 210 and abut the sides of block 204. Optional coil springs 212, 214 may be provided to increase the flexibility of rods 206, 208. Motion of the block 204 will move flexible rods 206, 208, thereby opening and closing the electrical circuit of between wiring 216 and wiring 218, which will connect from the battery (or any other power source) to the camera 150 (not shown). Dashed lines 206a and 208a illustrate a second position wherein the flexible rods are spread further apart by pressure from the block 204 rotating to the “locked” position (also shown in dashed lines) in orifice 220. This movement forces contact pad 222 on rod 206 to meet metal pad 224, while rod 208 similarly meets metal pad 226 through contact pad 228, stretching wire 230 and allowing electricity to flow through the circuit.

The circuitry would be open, deactivating the camera and the communication with the monitor, whenever the system is rotated 90° in order to unlatch the clamping device 98 from the rear of the vehicle. Block 232 acts as a stopper to prevent rods 206 and 208 from contacting and shorting.

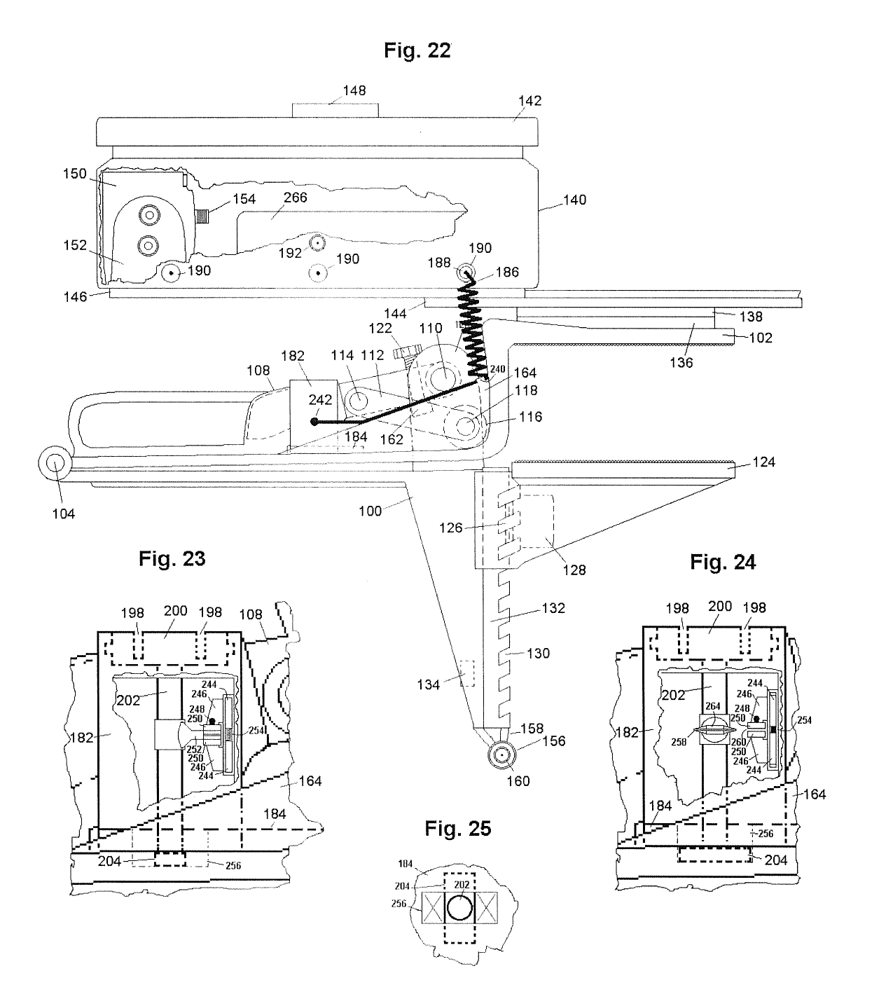

In the exemplary embodiment of a locking mechanism shown in FIGS. 22-25, like numbers denote like parts as in the embodiment shown in FIGS. 18-21. In this embodiment, wires 186 are connected through suitable, preferably weatherproof, passageways, such as grommets 242 into the wall of cylinder 194.

Detailed views of the locking/connecting mechanism 182 are shown in FIGS. 23-25. When an appropriate cylindrical key penetrates the circular groove 198 in revolving disk plate 200, it drives the shaft 202, and rotates rectangular block 204 thereby locking or opening the handle 108 of clamping device 98. In order to clamp the device onto a vehicle bumper, block 204 must be positioned within anchor plate 184 in slot 256 in the open position shown in FIG. 24. The key may then be turned to the locked position shown in FIGS. 23 and 25 after lever 108 is brought to closed position.

The hardware to open and close the circuitry which energizes the camera is also carried on shaft 202. The mechanism locks when shaft 202 rotates to bring arm 252, carrying contact pad 264 (best shown in FIG. 24) in line with contact pads 250. In this position the circuit from wire terminal 248, to the bottom terminal (not shown) on the opposite side is closed. Contact pads 250 are supported, such as by brackets 246 and guide blocks 244.

Guide blocks 244 are preferably spring biased together, such as by coil spring 254 as in FIG. 23, but also positioned to provide a small slot 260 between contacts 250, which may be provided by the physical presence of coil spring 254 between guide blocks 244, as best shown in FIG. 24. With this configuration, insertion of contact pad 264 between contact pads 250 will extend spring 254 and provide a sure contact between all three contact pads, as best shown in FIG. 23. When it is desired to remove the clamping device from the vehicle, the camera circuitry is disabled by rotating the shaft 202 and locking block 204 to move contact pad 264 away from contact pads 250, as shown in FIG. 24. Slot 260 between contact pads 250 prevents the assembly from short-circuiting. Tapered blades 258 may extend from contact pad 264 to ease the insertion of contact pad 264 into slot 260 when the mechanism is locked. Blades 258 may be provided on both sides of contact pad 264, as shown, which would allow the locking mechanism to lock over 180°, entering the slot 260 from either side, or may be provided only on one side of contact pad 264, if 90° rotation is sufficient for the locking cylinder used.

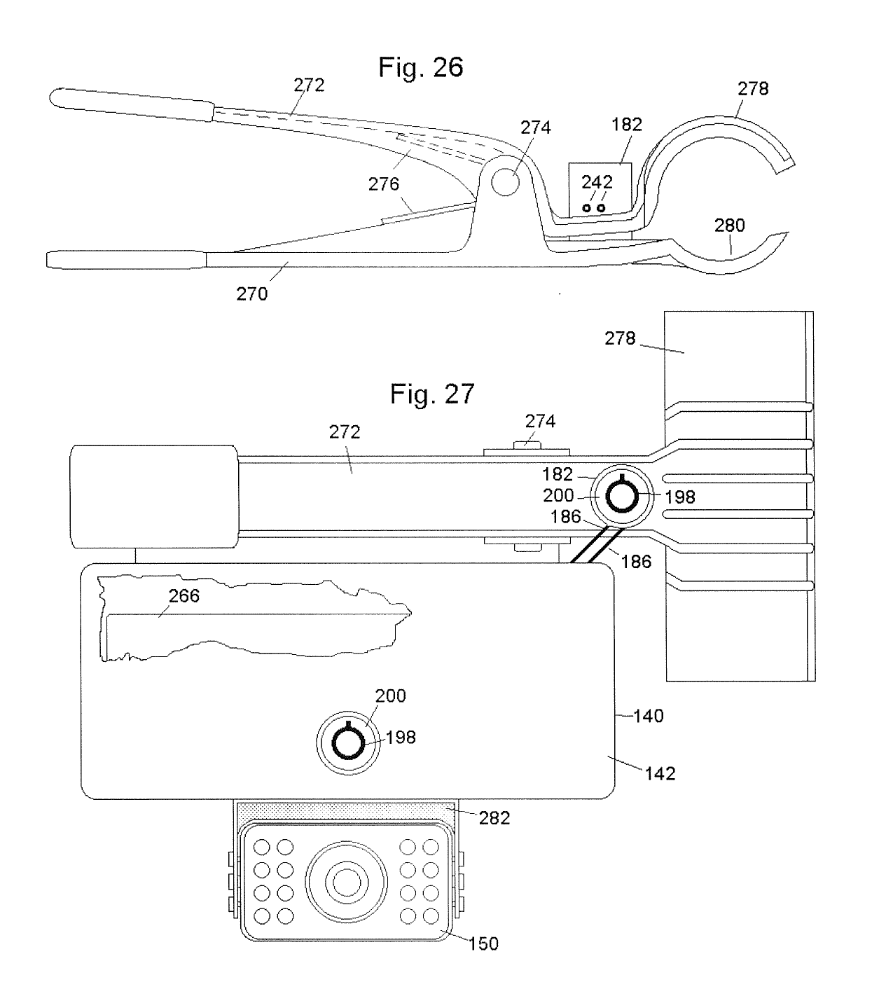

FIG. 26 shows another embodiment of the invention, in which the securing mechanism takes the form of a spring type clamp featuring locking hardware that synchronizes the camera circuitry with the locking of the device. Base 270 extends to lower jaw 280 while swivel plate 272, which pivots on axle 274, extends to upper jaw 278. Base 270 and swivel plate 272 are biased apart around axle 274 by spring 276. A locking/connecting mechanism 182, similar to the ones of FIGS. 22-24, may be provided. Grommets 242 or other suitable passageways may be provided in the sidewalls of mechanism 182 for the wires connecting the locking mechanism 182 between the camera circuitry and the power source.

FIG. 27 shows the spring clamp of FIG. 26 attached to a battery compartment 140, covered with locked lid 142, and a camera 150. As in other embodiments earlier described, disk plate 200 contains groove 198, into which a cylinder key is inserted to both lock swivel plate 272 as well as to control the function of the camera 150 via an electrical circuit comprising wires 186. The same key may open and lock the lid 142 of the compartment 140. Camera 150 may be external to the compartment 140 as shown, or may be accommodated with the compartment 140. In an external embodiment, additional security features, such as one or more protective metal plates 282, may be installed in and/or around the camera bracket to prevent tampering using metal shears, bolt cutters, etc.

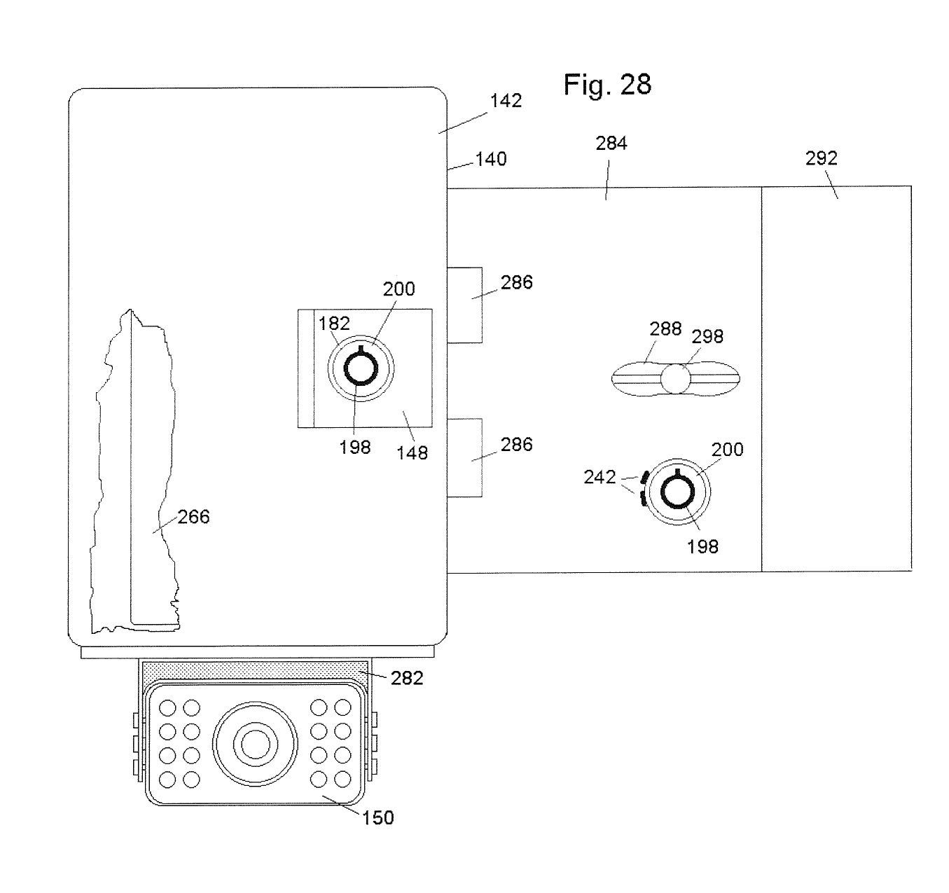

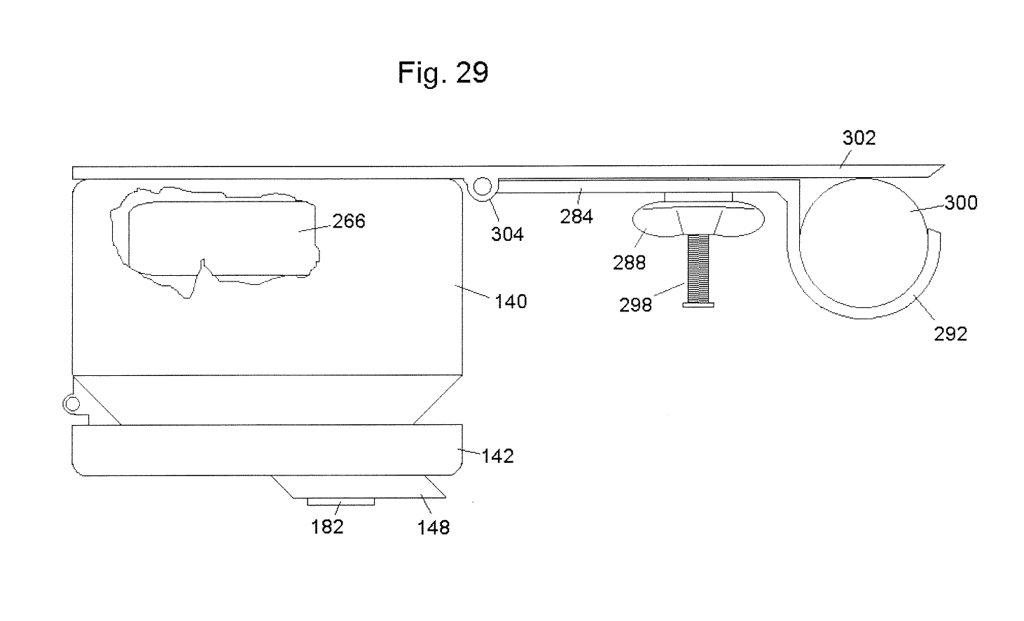

FIGS. 28 and 29 show another embodiment of the invention, in which the securing mechanism takes the form of a wing nut 288 on threaded shaft 298 to fasten the assembly onto vertical locking rods 300 installed at back of trucks and trailers. The battery compartment 140, having lid 142, may be attached to the chassis plate 302. Lid 142 may include knob 148 to host a lock mechanism which is operated by a key inserted into groove 198 of disk plate 200. Swivel plate 284, which extends parallel to chassis plate 302 to jaw 292, is connected, such as at hinge 304 to attach the mechanism to the vehicle at a suitable point, such as around locking rod 300. The mechanism is then secured by tightening wing nut 288 to force swivel plate 284 and jaw 292 towards chassis plate 302 and locking rod 300. This embodiment may also have locking/camera connecting capability as described in earlier embodiments, with circuit breaking hardware installed behind disk 200, with suitable connections, such as grommets 242, and wiring (not shown) provided.

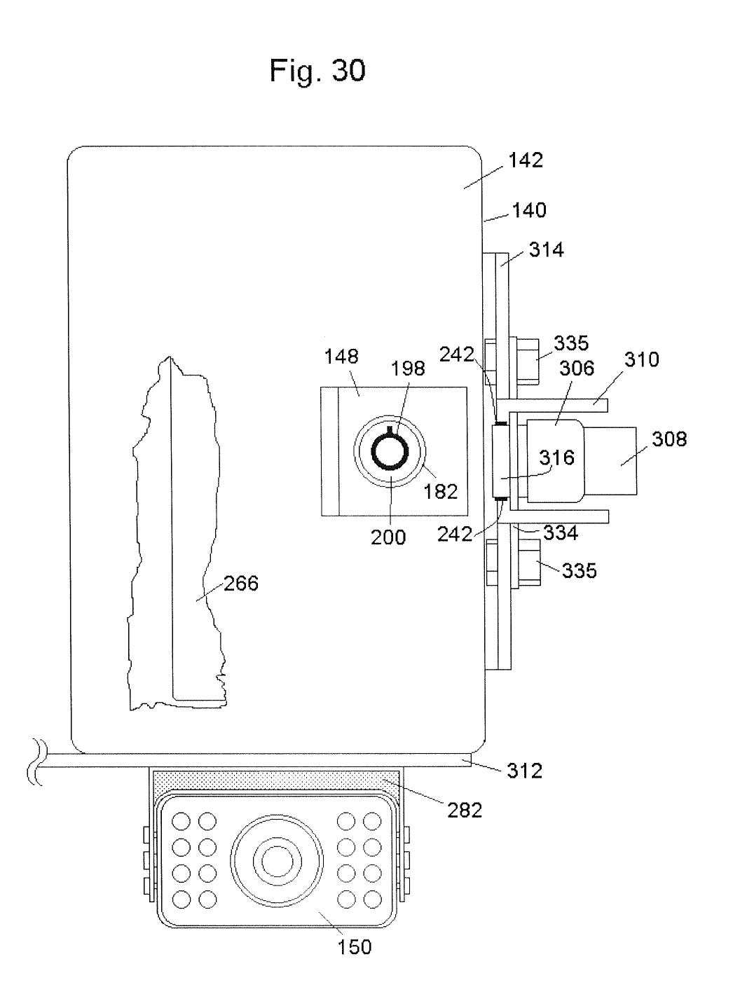

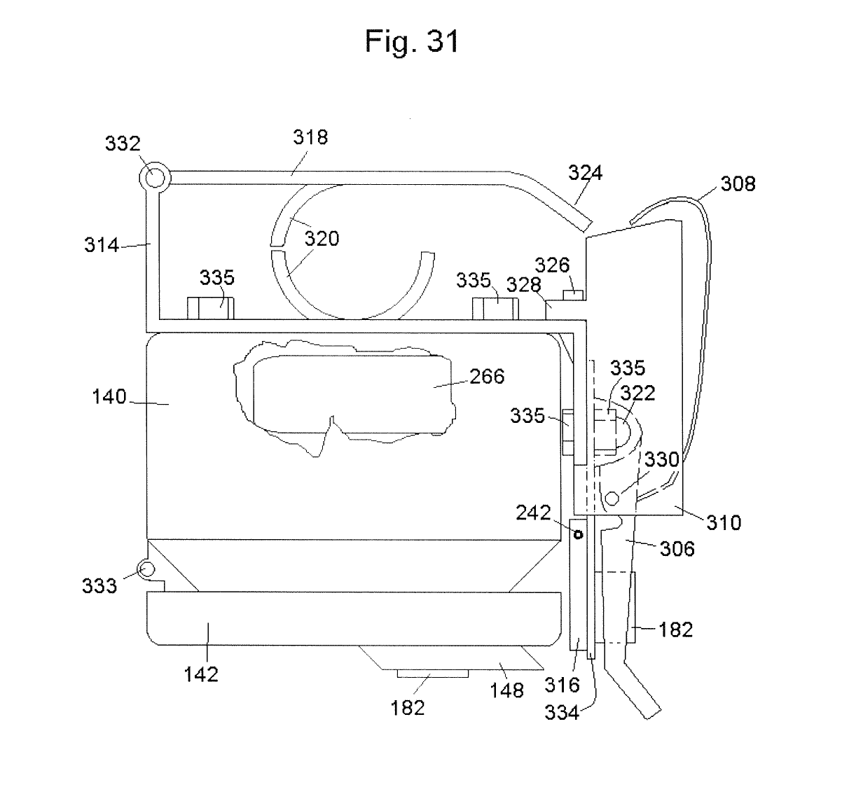

FIGS. 30 and 31 show another embodiment of the invention, in which the securing mechanism takes the form of a latching system using a hook leaf spring system. Compartment 140, which may be provided with a lid 142 hinged at 333 and locked by a locking mechanism 182 in knob 148, may be attached to chassis plate 314 and/or plate 334 by a removable mechanism such as one or more nuts 335. Lever 306 locks the system, and may be provided with a circuit breaker mechanism similar to those earlier described, inside box 316. If camera 150 is not contained within compartment 140, plate 312 may be provided to hold camera 150. Protective plate 282 may extend to either or both sides of camera 150 to host extra cameras or to place the only one on the dead center of the vehicle for an optimized central rear view. A revolving or rotational mechanism, such as that shown in FIGS. 16 and 17 may be provided to allow movement of the camera in one or more dimensions.

To install this embodiment of the device, swivel plate 318, hinged at 332 to chassis plate 314, is opened to embrace locking rods of the vehicle within circular brackets 320. The mechanism is closed and the leaf spring 308, pivoted at 330, is inserted into a slot 324 and tightened by lever 306, which is pivoted at 322. This locking mechanism may be protected against burglary by the extension of the chassis plate 314 on the channel bar 310, secured by an appropriate means such as bolts 326 passing through extensions 328.

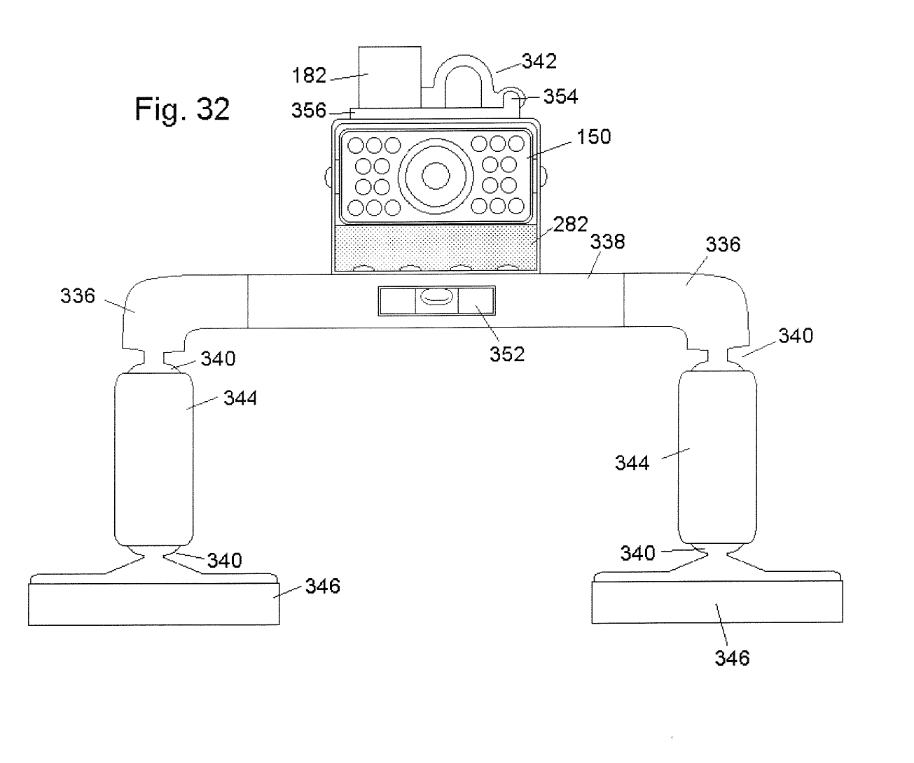

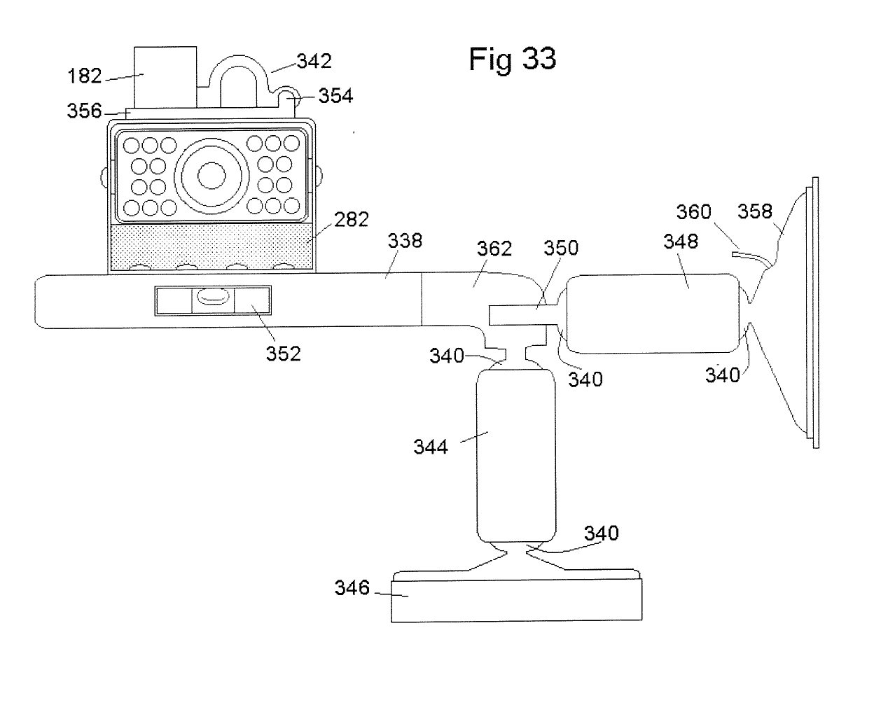

FIG. 32 shows another embodiment of the invention, designed for installation on the last vehicle carried by a car hauler's trailers or on the surrounding fixtures for an unloaded trailer. Chassis rod 336 supports segment 338, which preferably has 360° rotatability, and in turn supports camera 150 and its protective plate 282. This system is typically connected to the monitor in cab and it would be permanently connected to the trailer. An optional connector may be installed close to or on the camera 150, allowing it to be detached from the system whenever it is not in use. A locking system 182 similar to those previously described, which is in synch with the function of the camera, may also be installed. Anchor plate 356 is attached to the camera 150 and holds locking mechanism 182 which may also contain hardware to control the camera circuitry, such as that shown in FIGS. 23 and 24, or a control mechanism similar to that of FIG. 20 installed inside anchor plate 356. Arch 342, which may be attached such as by pivot 354, is provided to secure the assembly to the vehicle and operate the locking mechanism 182. External fasteners such as loops and wire ropes may be installed on the vehicle or trailer frame for attachment to the arch 342 as a secondary means to secure the assembly to the vehicle. In an alternative embodiment, the arch 342 may be removable from the assembly (i.e. detachable at pivot 354), but permanently secured to a wire rope on the vehicle frame. In this case, it would be necessary to connect the arch 342 to the assembly at pivot 354 in order to attach the assembly to the vehicle and to securely close the arch 342 before the locking system 182 will operate. The pertinent connections and wiring would preferably be installed and firmly secured at the back of the unit to avoid interfering with the camera or other parts of the assembly and to minimize movement under the influence of wind when the vehicle is moving, but are omitted for clarity. Rod 336 also holds at least one leg 344, articulated at joint 340, similar to ones on center rear view mirror of most vehicles on the road, to provide some flexibility and adaptability in locating and securing the mechanism to a vehicle. Bubble 352 may be provided if it is necessary or preferable to ensure that the unit is level. One or more magnetic pads 346 may be provided to attach the unit to an appropriate place on the trailer. One or both magnetic pads 346 may be replaced by a suction cup unit 358 (shown only in FIG. 33) or other suitable removable attachment means.

FIG. 33 is a similar embodiment to that shown in FIG. 32, with a slightly different configuration in which angle rod 362 holds leg 344, plus a second leg 348 articulating around joint 350 and holding suction cup 358 that has a vacuum control valve 360. This configuration may be preferable to operators, as it may be faster to attach it to a vehicle than the opposed leg configuration shown in FIG. 32.

It will be understood that all hardware touching the contact points in each embodiment are preferably to be made of non-conductive material. It will also be understood that the securing mechanisms and locks shown in FIGS. 19-33 are examples. Other suitable securing mechanisms may be used, once they have been connected or adapted to provide a signal or contact that allows the communications between the camera and the monitor to be controlled. It will be further understood that a conventional locksmith drum assembly could alternatively operate the system, however features such as durability, tamper-resistance, the ability to be connected to the battery compartment and having just one key to lock the whole system should be considered and are preferred.

While the present invention has been described with particular reference to various preferred embodiments, one skilled in the art will recognize from the foregoing discussion and accompanying drawing and claims that changes, modifications and variations can be made in the present invention without departing from the spirit and scope thereof, such scope being properly defined by the following claims.

1. A removable closed circuit television backup system for a vehicle, comprising:
a closed circuit television camera and a power source for said camera;
a monitor adapted to display an image from said camera; and
a securing mechanism to removably attach said camera to said vehicle;
said securing mechanism comprising a lock;
wherein locking of said lock connects said camera to said power source and initiates communication between said camera and said monitor, and unlocking of said lock terminates said communication between said camera and said monitor.

2. The backup system of claim 1, wherein said communication includes a synchronization protocol, in which said camera and said monitor pair with each other to exclude communications with other devices.

3. The backup system of claim 2, wherein said synchronization protocol is Bluetooth® SSP.

4. The backup system of claim 1, wherein said camera is in communication with said monitor by a wired connection.

5. The backup system of claim 1, wherein said camera is in communication with said monitor by a wireless connection.

6. The backup system of claim 1, wherein said securing mechanism is a clamping device comprising:
a pair of clamp arms having facing jaw plates, at least one of said jaw plates being adjustable to move toward and away from the opposing jaw plate; and
a tightener to adjust the pressure of said jaw plates.

7. The backup system of claim 6, further comprising:
at least one elongated railing affixed to one of said clamp arms, wherein said adjustable jaw plate is slidably movable along said railing; and
locking means to hold said jaw plate at various points along said railing.

8. The backup system of claim 7, wherein said railing includes a plurality of notches along its length, wherein said locking means comprises teeth and spring biased tabs to secure said teeth to said notches.

9. The backup system of claim 1, wherein said lock comprises a rotatable shaft, and rotation of said shaft to a first position completes an electrical circuit between said camera and a power source to initiate said communication between said camera and said monitor.

10. The backup system of claim 1, further comprising a compartment to house said camera, wherein locking of said lock also locks said compartment.

11. The backup system of claim 11 wherein said compartment also houses said power source.

12. The backup system of claim 1 wherein said securing mechanism is a spring clamp.

13. The backup system of claim 1 wherein said securing mechanism is secured by one or more wing nuts.

14. The backup system of claim 1 wherein said securing mechanism comprises a pair of legs, and said legs are secured to said vehicle by at least one fastener selected from the group consisting of magnets, suction cups.

15. The backup system of claim 14 wherein said legs are opposed to one another.
